(19) United States
(12) Patent Application Publication
(10) Pub. No.: US 2025/0135895 A1
(43) Pub. Date: May 1, 2025

(54) INFORMATION PROCESSING DEVICE AND INFORMATION PROCESSING METHOD

(71) Applicant: TOYOTA JIDOSHA KABUSHIKI KAISHA, Aichi-ken (JP)

(72) Inventors: Hiroshi YAMASAKI, Nagoya-shi (JP); Isao SATO, Nagoya-shi (JP); Tomoyoshi UEKI, Toyota-shi (JP); Nao MATSUBARA, Toyota-shi (JP)

(21) Appl. No.: 18/908,800

(22) Filed: Oct. 8, 2024

(30) Foreign Application Priority Data
Oct. 27, 2023 (JP) 2023-185040

(51) Int. Cl. B60L 3/00; B60L 58/10

(52) U.S. Cl. CPC B60L 3/0046; B60L 58/10

(57) ABSTRACT

The control unit of the information processing device determines priorities of collection of the plurality of stored batteries with reference to information related to damage to the plurality of batteries. Then, the control unit of the information processing device outputs instruction information for instructing collection of the plurality of batteries according to the determined priorities of collection of the plurality of batteries.

### CROSS-REFERENCE TO RELATED APPLICATION

This application claims priority to Japanese Patent Application No. 2023-185040 filed on Oct. 27, 2023, incorporated herein by reference in its entirety.

### BACKGROUND

### 1. Technical Field

The present disclosure relates to information processing devices and information processing methods.

### 2. Description of Related Art

Japanese Unexamined Patent Application Publication No. 2004-192268 (JP 2004-192268 A) discloses a method for planning waste transportation. In the method for planning waste transportation disclosed in JP 2004-192268 A, a plan is made to collect waste generated at each collection point in a certain area and transport the collected waste to a relay station before a waste disposal and treatment facility. In the method for planing waste transportation, possible routes for transporting waste in a certain area are held. In the method for planning waste transportation, the amount of waste to be collected at a plurality of collection points on each possible route and the packaging types of the waste are acquired. In the method for planning waste transportation, a collection route for traveling around the collection points, collecting waste at each collection point, and returning to the relay station is obtained based on the amount of waste to be collected at each collection point and the packaging types of the waste.

### SUMMARY

An object of the present disclosure is to allow safe storage of batteries.

An information processing device according to a first aspect of the present disclosure includes a control unit.

The control unit is configured to
determine priorities of collection of a plurality of stored batteries by referring to information related to damage to the batteries, and
   output instruction information for instructing collection of the batteries, based on the determined priorities of collection of the batteries.

An information processing method according to a second aspect of the present disclosure is an information processing method that is performed by a computer.

The information processing method includes:
determining priorities of collection of a plurality of stored batteries by referring to information related to damage to the batteries; and
outputting instruction information for instructing collection of the batteries, based on the determined priorities of collection of the batteries.

The present disclosure allows safe storage of batteries.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a collection system;

FIG. 2 is a block diagram schematically illustrating an example of a functional configuration of a server constituting a collection system;

FIG. 3 is a diagram illustrating an exemplary table configuration of battery information; and

FIG. 4 is a flowchart of processing executed by the control unit.

### DETAILED DESCRIPTION OF EMBODIMENTS

It is assumed that a plurality of stored batteries is collected. At this time, at least one of the plurality of batteries may be damaged. It is then assumed that the damaged battery increases the risk of storage. Therefore, the information processing device according to the first aspect of the present disclosure solves such a problem.

The control unit of the information processing device according to the first aspect of the present disclosure determines priorities of collection of a plurality of stored batteries by referring to information related to damage to the batteries. The control unit of the information processing device then outputs instruction information for instructing collection of the batteries, based on the determined priorities of collection of the batteries.

As described above, the information processing device determines priorities of collection, based on information related to damage to the batteries. Therefore, it is possible to suppress an increase in the risk of storage due to damage to the battery. As a result, the battery can be safely stored.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

### System Overview

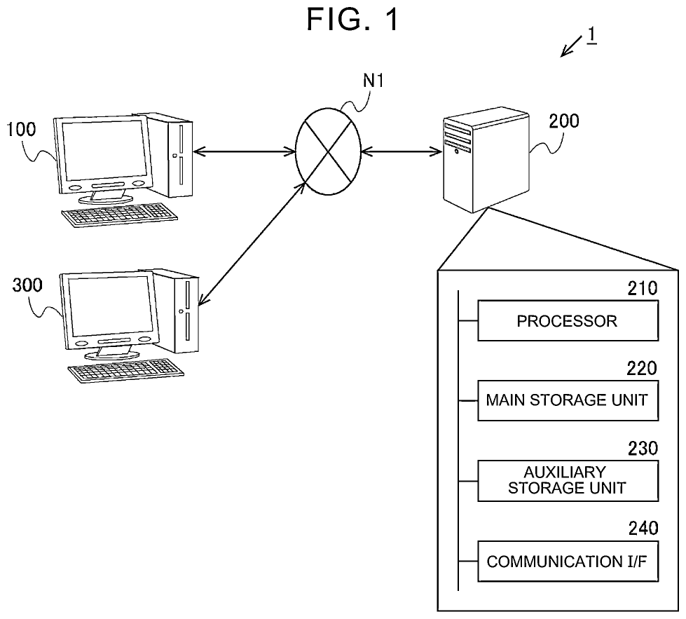

The collection system 1 according to the present embodiment will be described with reference to FIG. 1. FIG. 1 is a diagram illustrating a schematic configuration of a collection system 1. The collection system 1 includes a dealer terminal 100, a server 200, and a collection contractor terminal 300. In the collection system 1, the dealer terminal 100, the servers 200, and the collection contractor terminal 300 are connected to each other via a network N1. The network N1 may employ, for example, a Wide Area Network (WAN) which is a global public communication network such as the Internet, or a telephone communication network such as a cellular telephone.

### (Dealer Terminal)

The dealer terminal 100 is a terminal used by a dealer of a vehicle (hereinafter, may be simply referred to as a “dealer”). The dealer terminal 100 is, for example, a computer or a personal digital assistant used by the dealer.

The dealer removes a battery (hereinafter, sometimes simply referred to as a “battery”) attached to the vehicle. At this time, the dealer removes the battery from the vehicle in order to perform either the recycling process or the rebuild process. Then, the dealer stores the removed battery. Here, the battery is a battery for driving a motor such as a battery type battery electric vehicle or a hybrid-type battery electric vehicle. The battery may be a battery used for an auxiliary battery or the like in a vehicle.

The recycling process is a process for reusing a battery as a resource. The recycling process is, for example, a process of crushing a battery and extracting metal (iron, copper, gold, lithium, nickel, cobalt, or the like) contained in the battery as a resource. Thus, the extracted resources such as metal can be used for the manufacture of a new product.

Further, the rebuild process is a process used for rebuild in which part or all of the components are reused. The rebuild process is a process in which a battery is disassembled into a component and a reusable component is reused as a battery for another vehicle. Here, the component of the battery is, for example, a cell constituting the battery. Further, the components of the battery may be, for example, a module or a substrate constituting the battery. In such a case, the parts removed from the battery are reused as parts of the newly manufactured battery. In the rebuild process, the battery may be used as it is by re-assembling it as a battery for another vehicle without disassembling the battery.

In the present embodiment, the battery is a battery in which either the recycling process or the rebuilding process is performed after collection. However, the battery does not necessarily have to be a battery in which either the recycling process or the rebuilding process is performed after collection. The battery may be, for example, a battery that is discarded after collection.

The dealer terminal 100 transmits battery information to the server 200 via the network N1. Here, the battery information is information about the battery stored by the dealer. The battery information includes information related to a damaged state of the battery stored in the dealer. In the present embodiment, the information related to the damaged state of the battery is information about the presence or absence of a history of accident of the vehicle to which the battery is attached. The presence or absence of a history of accident of the vehicle is, for example, whether or not the vehicle has caused a collision accident. The presence or absence of a history of accident of the vehicle is, for example, whether or not the vehicle has been submerged in water. The battery information is generated by the dealer inputting information on the battery and information on the presence or absence of a history of accident of the vehicle to which the battery is attached to the dealer terminal 100.

### Server

The server 200 is a server device that manages collection of batteries stored by a dealer. The server 200 receives battery information from the dealer terminal 100 via the network N1. The server 200 transmits the instruction information to the collection contractor terminal 300 via the network N1. Here, the instruction information is information for instructing collection of a plurality of batteries stored in the dealer. At this time, the amount of the plurality of batteries held by the dealer may exceed the amount of batteries that can be collected by the collection company. In this case, the server 200 needs to set priorities of a plurality of batteries stored at the dealer and determine a battery to be collected out of the plurality of batteries based on the priorities.

Here, it is assumed that the vehicle to which the battery is attached is a vehicle in which an accident has occurred. In this case, the battery may be damaged due to an impact of the battery in the event of an accident. In addition, there is a possibility that the battery is damaged by submergence during submergence. As a result, a battery installed in a vehicle having a history of accident may ignite or leak. Therefore, it is assumed that a battery installed in a vehicle having a history of accident increases a risk during storage.

Therefore, the server 200 determines the priorities of collection of the plurality of batteries according to whether each of the vehicles in which the plurality of batteries is mounted has a history of accident. Details of a method for the server 200 to determine priorities of collection of a plurality of batteries will be described later.

The servers 200 are configured to include a computer having a processor 210, a main storage unit 220, an auxiliary storage unit 230, and communication interfaces (communication I/F) 240. The processor 210 is, for example, Central Processing Unit (CPU) or Digital Signal Processor (DSP). The main storage unit 220 is, for example, a Random Access Memory (RAM). The auxiliary storage unit 230 is, for example, a Read Only Memory (ROM). The auxiliary storage unit 230 is, for example, a Hard Disk Drive (HDD), a CD-ROM, DVD disc, or a disc recording medium such as a Blu-ray disc. The auxiliary storage unit 230 may be a removable medium (a portable storage medium). Examples of the removable medium include a USB memory or an SD card. The communication I/F240 is, for example, a Local Area Network (LAN) interface board or wireless communication circuitry for wireless communication.

In the servers 200, an operating system (OS), various programs, various information tables, and the like are stored in the auxiliary storage unit 230. Further, in the server 200, the processor 210 loads the program stored in the auxiliary storage unit 230 into the main storage unit 220 and executes the program, thereby realizing various functions as described later. However, some or all of the functions of the servers 200 may be implemented by hardware circuitry such as ASIC or FPGA. Note that the server 200 does not necessarily have to be realized by a single physical configuration, and may be constituted by a plurality of computers that cooperate with each other. The dealer terminal 100 includes a computer as in the case of the server 200.

### (Collection Operator Terminal)

The collection contractor terminal 300 is a terminal used by a contractor (collection contractor) who collects batteries. The collection contractor terminal 300 is configured to include a computer, similarly to the server 200. The collection contractor terminal 300 receives the instruction information from the servers 200 via the network N1. As a result, the collection company can recognize the batteries to be collected among the plurality of batteries stored by the dealer. As a result, a plurality of batteries stored in the dealer are collected by the collection company. Note that the battery does not necessarily have to be stored in a state of being removed from the vehicle. The battery may, for example, remain mounted on the vehicle and may be removed from the vehicle at the time of collection by the collection contractor. In addition, the collection company may collect the batteries for each vehicle.

In the present embodiment, the server 200 transmits the instruction information to the collection contractor terminal 300. However, the server 200 does not necessarily have to transmit the instruction information to the collection contractor terminal 300. For example, the server 200 may directly transmit the instruction information to the vehicle (the collection vehicle) that performs the collection of the battery. In this case, the instruction information includes information indicating a point at which the battery is collected and information indicating the battery to be collected. Then, the collection vehicle that has received the instruction information autonomously travels to the place where the dealer stores the battery in accordance with the instruction information, and displays information indicating the battery to be collected to the dealer. The dealer loads the battery on the collection vehicle according to the displayed information indicating the battery to be collected. In this way, the battery is collected.

### Functional Configuration

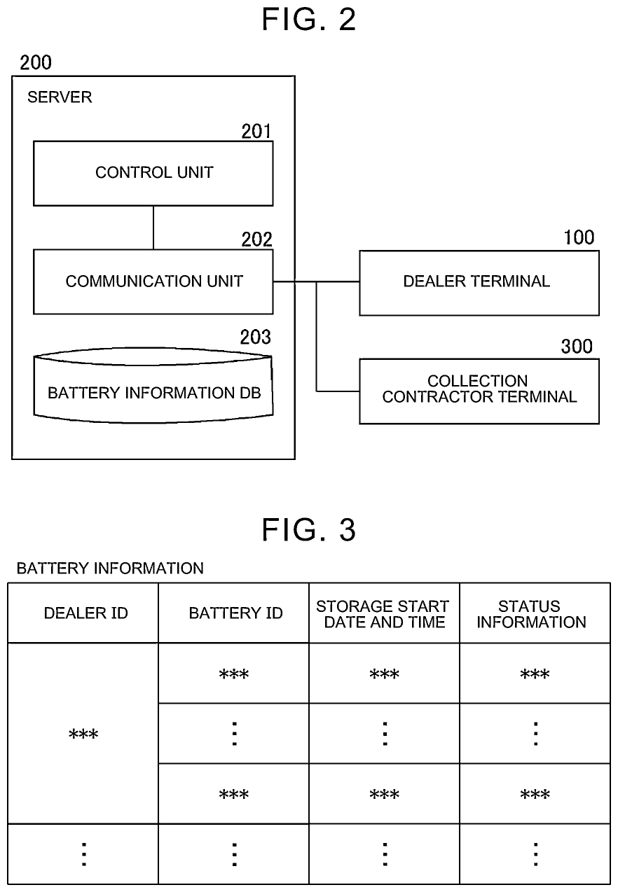

Next, the functional configuration of the server 200 constituting the collection system 1 will be described with reference to FIG. 2 to FIG. 3. FIG. 2 is a block diagram schematically illustrating an example of a functional configuration of the server 200 constituting the collection system 1.

The server 200 includes a control unit 201, a communication unit 202, and a battery information database 203 (battery information DB 203). The control unit 201 can be realized by the processor 210 in the server 200. The communication unit 202 has a function of connecting the servers 200 to a networked N1. The communication unit 202 can be realized by a communication I/F 240 in the servers 200.

The battery information DB 203 has a function of holding battery information. The battery-information DB203 can be realized by the auxiliary storage unit 230 in the servers 200. The control unit 201 receives battery information from the dealer terminal 100 via the communication unit 202. The control unit 201 stores the received battery information in the battery information DB 203. FIG. 3 is a diagram illustrating an example of a table configuration of battery information; The battery information includes a dealer ID field, a battery ID field, a storage starting date and time field, and a status information field.

In the dealer ID field, an identifier (dealer ID) for identifying the dealer that transmitted the battery information is stored. When the server 200 manages collection of batteries stored by a plurality of dealers, a plurality of dealer ID are stored in the battery data. In the battery ID field, an identifier (battery ID) for identifying a battery stored in a dealer of the corresponding dealer ID is stored. In the storage start date and time field, information indicating the date and time (storage start date and time) when the storage of the battery of the corresponding battery ID is started is stored. Here, the storage start date and time is the date and time when the battery is removed from the vehicle. The storage start date and time may be a date and time when the vehicle is taken to the dealer, or a date and time when the battery is discharged or charged last. In the status information field, information indicating the presence or absence of a history of accident of the vehicles to which the batteries of the corresponding battery ID field are attached is stored.

The control unit 201 can grasp the presence or absence of the battery stored in the dealer and a history of accident of the vehicle to which the battery is attached. Here, the amount of the plurality of batteries stored in the dealer may exceed the amount of batteries collected by the collection company (hereinafter, sometimes referred to as “collection amount by the company”). In this case, the control unit 201 refers to the battery information to determine priorities of collection of the plurality of batteries.

Specifically, the control unit 201 acquires, from the battery information, the presence or absence of a history of accident of the vehicle to which each of the plurality of batteries stored in the dealer is attached. Then, the control unit 201 determines that the priority of collection of the battery mounted on the vehicle with a history of accident (hereinafter, sometimes referred to as “specific battery”) is higher than the priority of collection of the vehicle attached to the vehicle with no history of accident. At this time, a plurality of specific batteries may be stored in the dealer. In addition, dealers may have more than one specific battery stored in excess of the vendor's collection.

Here, since the specific battery may be damaged, it is assumed that the longer the storage period, the greater the risk during storage. That is, it is assumed that a longer storage period increases a risk of ignition, a risk of liquid leakage, or the like. Therefore, the control unit 201 determines that the priority of collection of the battery with a longer storage period is higher than the priority of collection of the battery with a shorter storage period. Specifically, the control unit 201 calculates the storage period by referring to the storage start date and time stored in the storage start date and time field in the battery information. Then, the control unit 201 determines that the priority of collection of a specific battery with a long storage period out of the plurality of specific batteries is high. This makes it possible to preferentially collect a specific battery having an increased risk due to a longer storage period when a specific battery having an amount exceeding the contractor collection amount is stored.

In the present embodiment, the collection company collects the batteries stored in one dealer. However, the collection company may collect a plurality of batteries stored in a plurality of dealers existing in a predetermined area. In this case, when the amount of the plurality of batteries stored in the plurality of dealers exceeds the contractor collection amount, the control unit 201 determines priorities of collection of the plurality of batteries stored at the plurality of dealers.

The control unit 201 generates instruction information for instructing collection of a plurality of batteries stored at the dealer, based on the determined priorities. Here, the control unit 201 generates instruction information for instructing collection of batteries in descending order of priority. That is, the control unit 201 generates the instruction information so as to preferentially collect the specific batteries in descending order of storage period. In addition, when the amount of the specific battery is less than the contractor collection amount, the control unit 201 instructs to collect batteries other than the specific battery. In this way, the control unit 201 generates instruction information for instructing collection of the battery of the contractor collection amount. Then, the control unit 201 transmits the instruction information to the collection contractor terminal 300 by the communication unit 202.

### (Flowchart)

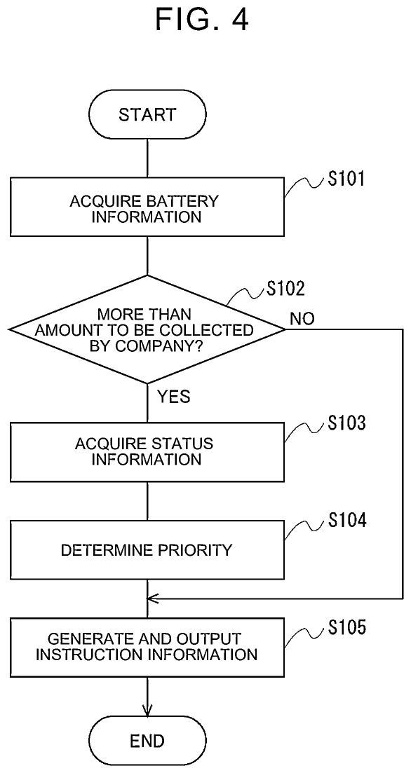

Next, processing executed by the control unit 201 in the server 200 in the collection system 1 will be described with reference to FIG. 4. FIG. 4 is a flowchart of processing executed by the control unit 201. This process is a process for outputting instruction information. The processing is executed at a predetermined timing. The predetermined timing is, for example, a timing at which the collection company collects the battery.

In the process illustrated in FIG. 4, first, in S101, battery information is acquired from the battery information DB 203. Next, in S102, it is determined whether the amount of batteries stored in the dealer exceeds the merchant collection amount. In S102, when a negative determination is made, the amount of batteries stored in the dealer does not exceed the amount collected by the dealer. Therefore, the collection company can collect all of the plurality of batteries stored in the dealer. Therefore, in S105, instruction information for instructing to collect all of the plurality of batteries stored in the dealer is generated and outputted to the collection contractor terminal 300. Then, the process illustrated in FIG. 4 is ended.

If an affirmative decision is made in S102, the quantity of batteries stored in the dealer exceeds the contractor's collection quantity. Therefore, the collection company cannot collect all of the plurality of batteries stored in the dealer. Therefore, it is necessary to determine priorities of collection of a plurality of batteries stored at a dealer. Therefore, in S103, the battery information is referred to, and the status information of each of the plurality of batteries stored in the dealer is acquired. Next, in S104, the priorities of collection are determined according to the status data on each of the plurality of batteries stored at the dealer. Next, in S105, the instruction information corresponding to the priorities of the collection is generated and output to the collection contractor terminal 300. In other words, in S105, the instruction information for collecting the batteries of the contractor collection amounts is generated and outputted in descending order of priority. Then, the process illustrated in FIG. 4 is ended.

As described above, in the collection system 1, the priority of collection of the specific battery is determined to be higher than the priority of collection of batteries other than the specific battery. Therefore, when a dealer stores a plurality of batteries including a specific battery and a battery other than the specific battery, the specific battery can be preferentially collected. Therefore, it is possible to accelerate the time of collection of the specific battery, and it is possible to suppress an increase in risk during storage.

Further, in the present embodiment, when a plurality of specific batteries are stored at a dealer, the priority of the battery with a long storage period is determined to be high. Thereby, the priority of collection of a specific battery with a long storage period, namely a battery whose damage may increase the risk during storage is determined to be high. Therefore, it is possible to preferentially collect a specific battery having an increased risk due to a longer storage period. In this way, a safe storage of the battery is possible.

### First Modification

In the present embodiment, the status information in the battery information held in the battery information DB 203 is information on the presence or absence of a history of accident of the vehicle to which the battery is attached. However, the state information in the battery information may not be information about the presence or absence of a history of accident of the vehicle to which the battery is attached.

Here, it is assumed that the greater the damage of the battery, the greater the risk during storage. Therefore, the state information in the battery information may be information indicating the level of damage to the battery. Here, the level of damage to the battery is represented by, for example, the number of damage to the cells in the battery. In this case, the larger the number of damage to the cells in the battery, the greater the damage to the battery. The dealer, for example, connects the battery to a diagnostic device to measure the extent of damage to the battery. Then, information on the level of damage to the battery output by the diagnosis device is output to the dealer terminal 100, thereby generating state information in the battery information.

Then, the server 200 determines priorities of collection of the batteries so that the higher the level of damage, the higher the priority of collection. At this time, a plurality of batteries having the same level of damage may be present. In this case, the server 200 determines the priority of collection of the battery with the longer storage period to be higher than the priority of collection of the battery with a shorter storage period. In this way, even if priorities are determined according to the level of damage to the battery, the batteries can be safely stored.

In addition, in a case where the battery is greatly damaged, it is assumed that the state of the battery can be grasped from the appearance. Therefore, the state information may be generated, for example, by the dealer confirming the appearance of the battery and inputting the level of damage to the battery to the dealer terminal 100. Further, it is assumed that the higher the water level when the vehicle (battery) is submerged in water, the larger the amount of water that has entered the battery. That is, it is assumed that the higher the water level when the vehicle (battery) is submerged in water, the greater the damage of the battery. Therefore, the state information may be, for example, information about the water level when the vehicle (battery) is submerged in water. In this case, for example, the dealer inputs information on the water level at the time of submergence to the dealer terminal 100. Even in this manner, the battery can be safely stored.

In addition, it is assumed that the level of the damage of the battery installed in the vehicle having a history of accident varies depending on the level of the accident. Therefore, the server 200 may determine the priority of the collection of the battery by using both the information about the presence or absence of a history of accident of the vehicle and the information indicating the level of the damage to the battery. The server 200 may, for example, determine the priority of collection of a battery mounted on a vehicle with a history of accident and with a level of damage equal to or higher than a first predetermined value to be the highest. The server 200 may, for example, determine the priority of collection of a battery mounted on a vehicle with a history of accident and with a level of damage less than the first predetermined value and equal to or higher than a second predetermined value to be the second highest.

As described above, the server 200 determines priorities of collection by referring to both the information as to whether the vehicle has a history of accident and the information indicating the level of damage to the battery. As a result, it is possible to preferentially collect a battery that is attached to a vehicle having a history of accident and has a large damage. Even in this manner, the battery can be safely stored.

### Second Modification

The battery in the present embodiment is a battery attached to a vehicle. However, the battery to be collected does not necessarily have to be a battery attached to the vehicle. For example, the battery may be an arbitrary battery such as a battery attached to an electric appliance or a stationary storage battery, and the battery may be a battery that is subjected to a recycling process or a rebuild process.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Examples of the non-transitory computer-readable storage medium include a random disk (such as a magnetic disk (a floppy disk an HDD, and the like) or an optical disc (such as a CD-ROM, a DVD disc, and a Blu-ray disc)), a ROM, a RAM, an EPROM, an EEPROM, a magnetic card, a flash memory, an optical card, and a random type of medium suitable for storing electronic instructions.

What is claimed is:

1. An information processing device comprising a control unit configured to
determine priorities of collection of a plurality of stored batteries by referring to information related to damage to the batteries, and
output instruction information for instructing collection of the batteries, based on the determined priorities of collection of the batteries.

2. The information processing device according to claim 1, wherein
the battery is a vehicle battery mounted on a vehicle,
the information related to damage to the batteries includes information as to whether each of the vehicles on which a corresponding one of the batteries is mounted has a history of accident, and
determining the priorities includes determining that, of the batteries, the battery mounted on the vehicle with a history of accident has a higher priority.

3. The information processing device according to claim 1, wherein
the information related to damage of the batteries includes information related to levels of the damage to the batteries, and
determining the priorities includes determining that, of the batteries, the battery with a higher level of damage has a higher priority.

4. The information processing device according to claim 1, wherein
determining the priorities includes determining the priorities based further on lengths of storage periods of the batteries.

5. An information processing method that is performed by a computer, the information processing method comprising:
determining priorities of collection of a plurality of stored batteries by referring to information related to damage to the batteries; and
outputting instruction information for instructing collection of the batteries, based on the determined priorities of collection of the batteries.
